(19) United States
(12) Patent Application Publication
(10) Pub. No.: US 2012/0170490 A1
(43) Pub. Date: Jul. 5, 2012

(54) MULTIMEDIA CONTENT DELIVERY OVER FEMTOCELL

(75) Inventors: Jangwon Lee, San Diego, CA (US); Samir S. Soliman, San Diego, CA (US)

(73) Assignee: QUALCOMM Incorporated, San Diego, CA (US)

(21) Appl. No.: 12/984,416

(22) Filed: Jan. 4, 2011

(51) Int. Cl. H04W 4/00

(52) U.S. Cl. 370/259

(57) ABSTRACT

Systems, methods, devices, and computer program products are described for multimedia content delivery in a femtocell. A mobile device may transmit multimedia content control information via wireless wide area network (WWAN) spectrum to a femtocell. The femtocell may access the multimedia content set forth in the received control information, and transmit the multimedia content over white space spectrum to a video display.

### BACKGROUND

The following relates generally to wireless communication, and more specifically to multimedia content delivery over a femtocell. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and various combinations thereof.

Generally, a wireless multiple-access communications system may include a number of base stations, each simultaneously supporting communication for multiple mobile terminals. Base stations may communicate with mobile terminals on downstream and upstream links. Each base station has a coverage range, which may be referred to as the coverage area of the cell. In cellular deployments, the macrocell is used to describe a cell serving a wide region such as rural, suburban, and urban areas. A “femtocell” is a smaller cell, typically deployed for use in a home, small business, building, or other limited region. It often is connected to a service provider's network via a broadband connection. In 3GPP terms, femtocells may be referred to as Home Node Bs (HNB) for UMTS (WCDMA, or High Speed Packet Access (HSPA)), and Home eNode Bs (HeNB) for LTE.

Benefits of femtocells may include (1) improved user experience at home (better coverage for voice and higher data throughput), (2) offloading traffic load from a macrocell network, and (3) reduction of infrastructure deployment costs, etc. It may be valuable to consider how the improved coverage and bandwidth availability may be further leveraged to provide enhanced services.

### SUMMARY

The described features generally relate to one or more improved systems, methods, and/or devices for multimedia content delivery in femtocells. Further scope of the invention will become apparent from the following detailed description, claims, and drawings. The detailed description and specific examples are given by way of illustration only, since various changes and modifications within the spirit and scope of the description will become apparent to those skilled in the art.

Systems, methods, devices, and computer program products are described for multimedia content delivery in a femtocell. A mobile device may transmit multimedia content control information via wireless wide area network (WWAN) spectrum to a femtocell. The femtocell may access the multimedia content identified by the received control information, and transmit the multimedia content over white space spectrum to a video display.

One example of a system of multimedia content delivery includes a mobile device, in communication with a femtocell via wireless wide area network (WWAN) spectrum, and configured to transmit multimedia content control information to the femtocell over the WWAN spectrum. The system also includes the femtocell, configured to receive the multimedia content control information over the WWAN spectrum and transmit, responsive to the multimedia content control information, multimedia content over white space spectrum to a video display. The mobile device may be further configured to generate and display a user interface to allow a user of the mobile device to select the multimedia content. The white space spectrum may be spectrum allocated to broadcasting services nationally, but unallocated locally. The femtocell is further configured to monitor spectrum, including the white space spectrum, allocated to broadcasting services nationally to detect signals from television stations and signals from auxiliary service stations and identify the white space spectrum based at least in part on the monitoring. The multimedia content may include one or more layers of encoded video to enhance video quality for a broadcast program displayed on the video display The white space spectrum may include spectrum allocated for use with a Forward Link Only air interface specification.

The system may include a home computing device, in communication with the femtocell and distinct from a mobile device, wherein the femtocell is further configured to retrieve the multimedia content from the Internet via the home computing device. The system may retrieve the multimedia content via a wired connection to the Internet, the retrieval responsive to the multimedia content control information. The system may receive broadcast signals, and identify a selected one of the broadcast signals as the multimedia content.

An example of a method of multimedia content delivery includes: receiving multimedia content control information via wireless wide area network (WWAN) spectrum from a mobile device; and transmitting, responsive to the received multimedia content control information, multimedia content over white space spectrum to a video display. The white space spectrum may include spectrum allocated to broadcasting services nationally, but unallocated locally. The multimedia content may include one or more layers of encoded video to enhance video quality for a broadcast program on the video display received via a wired connection. The white space spectrum may include spectrum allocated to a Forward Link Only air interface specification

Examples of such a method may include retrieving the multimedia content via the Internet, the retrieval responsive to the multimedia content control information; receiving a number of broadcast signals, and identifying, according to the multimedia content control information, a selected one of the broadcast signals as the multimedia content; monitoring spectrum allocated to broadcasting services nationally including the white space spectrum to detect signals from television stations and signals from auxiliary service stations, and identifying the white space spectrum based at least in part on the monitoring.

An exemplary femtocell for multimedia content delivery includes: a wireless wide area network (WWAN) spectrum receiver, configured to receive multimedia content control information via WWAN spectrum from a mobile device; a white space spectrum transmitter, communicatively coupled with the WWAN spectrum receiver, and configured to transmit multimedia content over the white space spectrum directed to a video display; and a multimedia content module, communicatively coupled with the WWAN spectrum receiver and the white space spectrum transmitter, to process the multimedia content control information, and identify the multimedia content for transmission. The multimedia content module may retrieve the multimedia content via the Internet. The multimedia content module may receive a number of broadcast signals and process the multimedia content control information to identify the multimedia content for transmission from the number of broadcast signals. The white space spectrum may be spectrum allocated to broadcasting services nationally, but unallocated locally. A white space detection module may monitor spectrum allocated to broadcasting services nationally, including the white space spectrum, and detect signals from television stations and signals from auxiliary service stations to identify the white space spectrum. The multimedia content may be one or more layers of encoded video useable to integrate with a broadcast program on the video display to enhance video quality. The white space spectrum may be spectrum allocated to a Forward Link Only air interface specification.

An example of a device for multimedia content delivery includes: means for receiving multimedia content control information via wireless wide area network (WWAN) spectrum from a mobile device; and means for transmitting, responsive to the received multimedia content control information, multimedia content over white space spectrum dto a video display. The device may include means for retrieving the multimedia content via the Internet, the retrieval responsive to the multimedia content control information. The device may include means for receiving a plurality of broadcast signals, means for identifying, according to the multimedia content control information, a selected one of the broadcast signals as the multimedia content. The device may include means for monitoring spectrum allocated to broadcasting services nationally including the white space spectrum to detect signals from television stations and signals from auxiliary service stations, and means for identifying the white space spectrum based at least in part on the monitoring. The white space spectrum may be spectrum allocated to broadcasting services nationally but unallocated locally. The device may include means for retrieving one or more layers of encoded video formatted to enhance video quality for a broadcast program on the video display. The white space spectrum may be spectrum allocated to a Forward Link Only air interface specification.

An example of a computer program product includes a computer-readable medium including code for receiving multimedia content control information via wireless wide area network (WWAN) spectrum from a mobile device and code for transmitting, responsive to the received multimedia content control information, multimedia content over white space spectrum directed to a video display. The computer-readable medium may further include code for retrieving the multimedia content responsive to the multimedia content control information; and code for receiving broadcast signals and identifying, according to the multimedia content control information, a selected one of the broadcast signals as the multimedia content. The computer-readable medium may further include code for monitoring spectrum allocated to broadcasting services nationally to detect signals from television stations and signals from auxiliary service stations, and code for identifying the white space spectrum based at least in part on the monitoring.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A is a block diagram of a wireless communications system for the delivery of multimedia content;

FIG. 1B is a block diagram of a wireless communications system for the delivery of multimedia content in a femtocell using FLO spectrum;

FIG. 1C is a block diagram of a wireless communications system for the delivery of multimedia content in a femtocell;

FIG. 2 is a block diagram of a femtocell used for multimedia content delivery in a wireless communications system;

FIG. 3 is a block diagram of an example of a processor module for the delivery of multimedia content in a femtocell;

FIG. 4 is a block diagram illustrating an example of a mobile device;

FIG. 5 is a flowchart of a method for multimedia content delivery at a femtocell;

FIG. 6 is a flowchart of a method for the retrieval and delivery of multimedia content delivery at a femtocell;

FIG. 7 is a flowchart of a method for multimedia content delivery at a femtocell using FLO spectrum; and

FIG. 8 is a flowchart of a method for monitoring white space spectrum and transmitting layers of encoded video data over a femtocell.

### DETAILED DESCRIPTION OF THE INVENTION

Systems, methods, devices, and computer program products are described for multimedia content delivery in a femtocell. A mobile device may transmit multimedia content control information via wireless wide area network (WWAN) spectrum to a femtocell. The femtocell may access the multimedia content identifiable through the received control information, and wirelessly transmit the multimedia content over white space spectrum to a video display.

Techniques described herein may be used for various wireless communications systems such as CDMA, TDMA, FDMA, and OFDMA. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

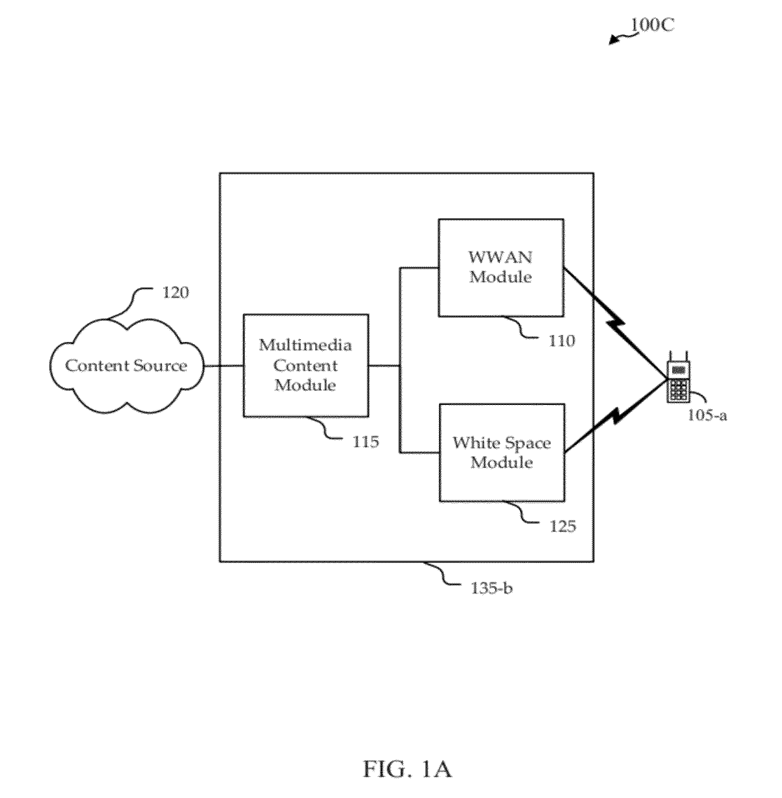

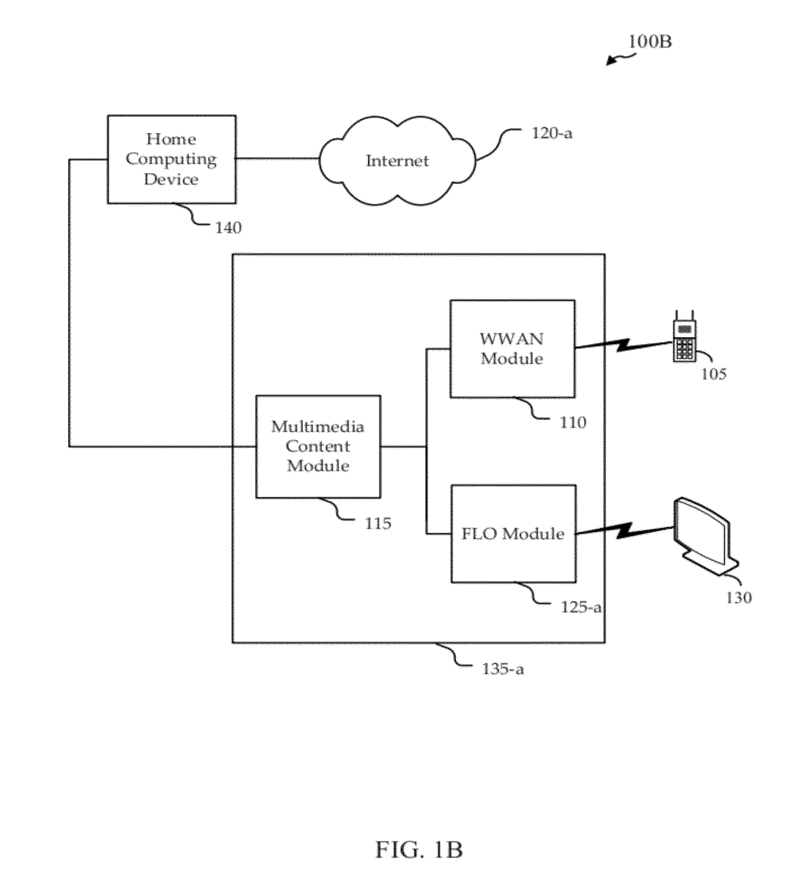

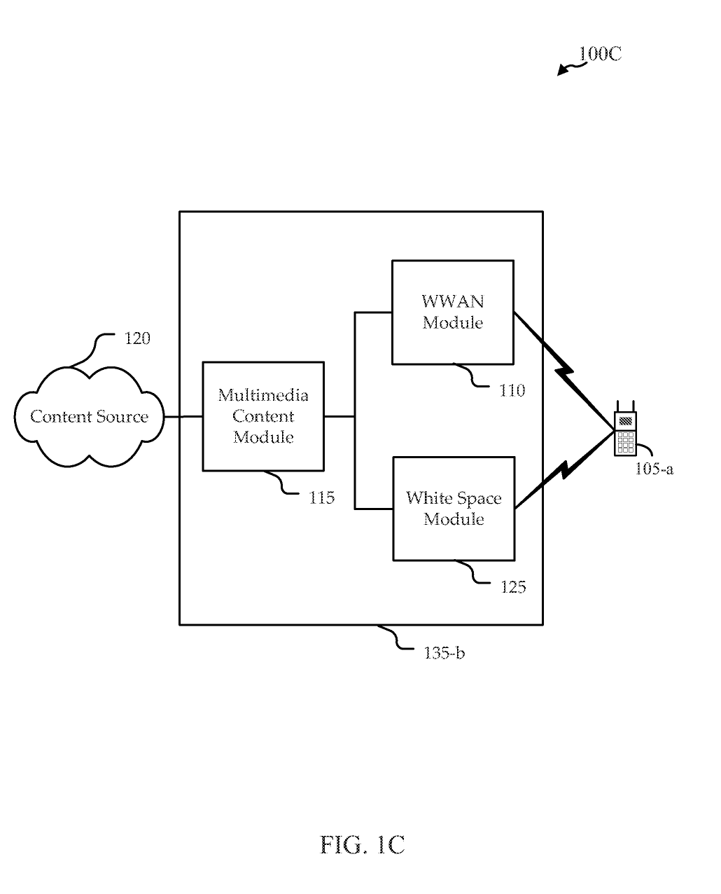

Referring first to FIG. 1A, a block diagram illustrates an example of a wireless communications system 100A. The system 100A includes a mobile device 105, a femtocell 135, a content source 120, and a display 130. The femtocell 135 includes a wireless wide-area network (WWAN) module 110, a multimedia content module 115, and a white space module 125. Each of these components may be in communication with each other, directly or indirectly.

These components of the femtocell 135 may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The mobile device 105 may transmit multimedia content control information via WWAN spectrum to the WWAN module 110. The multimedia content control information may include information identifying multimedia content selected by a user of the mobile device 105. The multimedia content module 115 may receive and process the multimedia content control information, and then may access the multimedia content (e.g., via a wired or wireless connection to the Internet or via a local media server). The multimedia content module 115 may process and transform the multimedia content to prepare the content for transmission. The white space module 125 may wirelessly transmit the multimedia content over white space spectrum to a video display 130.

The WWAN module 110, multimedia content module 115, and white space module 125 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a SC-FDMA signal, etc. Each modulated signal may be sent on a different carrier and may carry control information (e.g., pilot signals), overhead information, data, etc. The system 100A may be a multi-carrier LTE network.

A mobile device 105 may be referred to as a mobile station, access terminal (AT), user equipment (UE), or subscriber unit. A mobile device 105 may be a cellular phone or wireless communications device, or may be a personal digital assistant (PDA), other handheld device, netbook, laptop computer, etc.

For the discussion below, a mobile device 105 may operate on (be “camped” on) a macrocell or similar network facilitated by multiple base transceiver stations (not shown). Although a macrocell is used for purposes of example, the principles described herein may be applied to micro or pico cells, as well. Each macrocell may cover a relatively large geographic area (e.g., several kilometers in radius) and may allow unrestricted access by terminals with service subscription.

The mobile device 105 may generally operate using an internal power supply, such as a small battery, to facilitate highly mobile operation. Strategic deployment of network devices, such as femtocells 135, may be used to mitigate mobile device 105 power consumption. For example, a femtocell 135 may be utilized to provide service within areas which might not otherwise experience adequate or even any service (e.g., due to capacity limitations, bandwidth limitations, signal fading, signal shadowing, etc.), thereby allowing mobile devices 105 to reduce searching times, to reduce transmit power, to reduce transmit times, etc. A femtocell 135 may provide service within a relatively small service area (e.g., within a house or building). Accordingly, a mobile device 105 is typically disposed near a femtocell 135 when being served, often allowing the mobile device 105 to communicate with reduced transmission power.

By way of example, the femtocell 135 may be implemented as a Home Node B (“HNB”) located in a user premises, such as a residence, an office building, etc. The femtocell 135 location with a building may be chosen for maximum coverage (e.g., in a centralized location), to allow access to a global positioning satellite (GPS) signal (e.g., near a window), or in other locations. The disclosure herein assumes that one or more mobile devices 105 are registered on (e.g., on a whitelist of) a single femtocell 135 that provides coverage over substantially an entire user premises. The femtocell 135 provides the mobile device 105 with access to communication services via a connection (e.g., a broadband connection) to the macrocell network. As used herein, the macrocell network is assumed to be a wireless wide-area network (WWAN). As such, terms like “macrocell network” and “WWAN network” are interchangeable. Similar techniques may be applied to other types of network environments, coverage topologies, etc., without departing from the scope of the disclosure or claims.

In some examples, the femtocell 135 may be integrated with one or more out-of-band (OOB) communication modules. In the depicted example, the femtocell 135 includes a white space module 125 to transmit multimedia content to a display 130 over white space spectrum (which is OOB spectrum). As used herein, “out-of-band,” or “OOB,” includes any type of communications that are out of band with respect to the macrocell network (or a micro or pico cell, as applicable). For example, the femtocell 135 may be configured to operate using white space spectrum (54-72 MHz, 76-88 MHz, 174-216 MHz and 470-806 MHz, or available spectrum served by a Forward Link Only air interface specification (hereinafter, “FLO spectrum”), Bluetooth (e.g., class 1, class 1.5, and/or class 2), ZigBee (e.g., according to the IEEE 802.15.4-2003 wireless standard), and/or any other useful type of communications out of the macrocell band. OOB integration may provide a number of features. For example, the OOB modules may allow for reduced interference, lower power registration, and/or reselection, etc.

As noted above, the mobile device 105 may transmit multimedia content control information via WWAN spectrum to the WWAN module 110 at the femtocell 135. The mobile device 105 may generate and display a user interface to allow a user of the mobile device 105 to select and control delivery of multimedia content. The selection may be indicated in the multimedia content control information. The communication between the mobile device 105 and the WWAN module 110 may be bi-directional, with the WWAN module 110 transmitting programming information or guides in response to inquiries from the mobile device 105 user.

The multimedia content module 115 may receive and process the multimedia content control information, and then may access the multimedia content identified by the received control information (e.g., via a broadband connection to the Internet, a set top box, a local media server, or a local storage device). The multimedia content module 115 may be connected with the content source 120 via a wired or wireless connection, or combination thereof (e.g., a Wi-Fi connection to a broadband modem with a wired connection to the Internet).

The multimedia content module 115 may process and transform the multimedia content (e.g., according to the Advanced Television Systems Committee (ATSC) standards) to prepare the content for transmission. The white space module 125 may wirelessly transmit the multimedia content over white space spectrum to a video display 130.

As noted, the multimedia content module 115 may retrieve the multimedia content via a wired connection to the Internet. This retrieval may occur via a home computing device (e.g., a laptop or personal computer), in communication with the femtocell 135 and distinct from the mobile device 105. This link may also serve to connect the femtocell 135 with the service provider's network. In some examples, the multimedia content module 115 may receive broadcast signals (e.g., FLO or cable broadcast signals), and identify a selected one of the broadcast signals for transmission via the white space spectrum, the selected signal identified according to the multimedia content control information.

The white space spectrum may be made up of spectrum allocated to broadcasting services nationally (e.g., across the U.S.), but unallocated locally. The white space module 125 may access a data store which lays out white space for given geographic regions, and then identify the white space spectrum by including location data in the query. In another example, the white space module 125 may monitor spectrum, including the white space spectrum, allocated to broadcasting services nationally to detect signals from television stations and signals from auxiliary service stations (e.g., from wireless microphones). By identifying the unused frequencies, the white space module 125 may thereby identify the white space spectrum.

Multimedia content includes any combination of text, audio, still images, animation, video, and interactivity content forms. Multimedia content may also include one or more layers of encoded video or graphics to enhance video quality (e.g., for a broadcast program displayed on the video display). In addition, multimedia content may also include one or more layers of encoded FLO video to enhance video quality of a FLO stream transmitted over white space or, more specifically, over FLO spectrum. Multimedia content should, therefore, be interpreted broadly.

Referring next to FIG. 1B, a block diagram illustrates an example of a wireless communications system 100B. The system 100B includes a mobile device 105, a femtocell 135-a, a home computing device 140, the Internet 120-a, and a display 130. The femtocell 135-a includes a wireless wide-area network (WWAN) module 110, a multimedia content module 115, and a FLO module 125-a. Each of these components may be in communication with each other, directly or indirectly. This system may be an example of the system 100A of FIG. 1A.

The mobile device 105 may transmit multimedia content control information via WWAN spectrum to the WWAN module 110. The multimedia content control information may include information identifying multimedia content to be retrieved by the multimedia content module 115. The multimedia content module 115 may access the multimedia content set forth in the received control information (e.g., from the Internet 120-a via the home computing device 140). The multimedia content module 115 may process and transform the multimedia content to prepare the content for transmission over the FLO spectrum to a FLO-enabled display. The FLO module 125-a may wirelessly transmit the multimedia content over unused FLO spectrum to a FLO-enabled display 130.

Referring next to FIG. 1C, a block diagram illustrates another example of a wireless communications system 100C. The system 100C includes a mobile device 105-a, a femtocell 135-b, and a content source 120. The femtocell 135-b includes a wireless wide-area network (WWAN) module 110, a multimedia content module 115, and a white space module 125. Each of these components may be in communication with each other, directly or indirectly. This system may be an example of the system 100A, 100B of FIG. 1A or 1B.

The mobile device 105-a may transmit multimedia content control information via WWAN spectrum to the WWAN module 110. The multimedia content control information may include information identifying multimedia content to be retrieved by the multimedia content module 115. The multimedia content module 115 may retrieve the multimedia content from the content source 120. The multimedia content module 115 may process and transform the multimedia content to prepare the content for transmission over white space (e.g., according to the ATSC or other relevant standard). The white space module 125 may wirelessly transmit the multimedia content over white space to the mobile device 105-a. Thus, the mobile device 105-a may be a dual-mode device configured to receive multimedia content over white space spectrum (which may, e.g., include unused FLO spectrum). In other examples, the mobile device 105-a may transmit multimedia content control information via FLO spectrum, and receive the multimedia content over FLO or other white space spectrum. Those skilled in the art will recognize the numerous options.

Referring next to FIG. 1D, a block diagram illustrates another example of a wireless communications system 100D. The system 100D includes a mobile device 105, a femtocell 135-c, a multimedia content control device 115-a, a content source 120, and a display 130. The femtocell 135-c includes a wireless wide-area network (WWAN) module 110 and a white space module 125. Each of these components may be in communication with each other, directly or indirectly.

The mobile device 105-a may transmit multimedia content control information via WWAN spectrum to the WWAN module 110. The multimedia content control information may include information identifying multimedia content to be retrieved by the multimedia content control device 115-a. In the illustrated example, the multimedia content control device 115-a is separate from the femtocell 135-c (e.g., the multimedia content control device 115-a may be in wired or wireless communication with the femtocell 135-c). The multimedia content control device 115-a may be a local media server or a home personal computer. The multimedia content control device 115-a may retrieve the multimedia content from the content source 120 (the content source may be the multimedia content control device 115-a itself). The multimedia content control device 115-a or the femtocell 135-c may process and transform the multimedia content to prepare the content for transmission over white space (e.g., according to the ATSC or other relevant standard). The white space module 125 may wirelessly transmit the multimedia content over white space to the display 130.

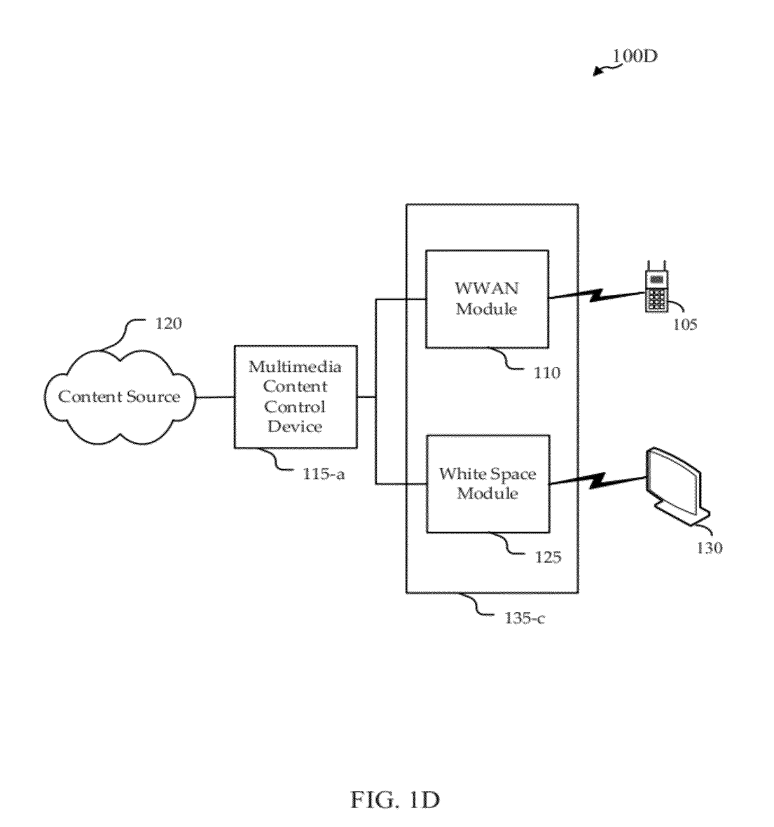

FIG. 2 shows a block diagram illustrating multimedia content delivery using a femtocell 135-c in a wireless communications system 200. The system 200 may be an example of the communications system 100 of FIG. 1A, 1B, or 1C. The femtocell 135-c may be integrated in a single device, or be made up of a number of networked devices (i.e., a number of different devices in communication with each other, directly or indirectly, providing the functionality of the femtocell 135-c). The femtocell 135-c includes antenna(s) 205, a WWAN transceiver module 210, and a WWAN sub-module 215, which collectively may function to communicate over WWAN spectrum. The femtocell 135-c also includes white space sub-module 225, WS transceiver module 230, and antenna(s) 235, which collectively may function to facilitate communication over white space spectrum. In addition, femtocell 135-c includes a multimedia content module 115, a communications management subsystem 220, and memory 225.

Each of the components of the femtocell 135-c may be in communication, directly or indirectly, with each other (e.g., over one or more buses). The WWAN transceiver module 210 may be configured to communicate bi-directionally, via the antennas 205, with the mobile device 105 over WWAN spectrum. The WS transceiver module 230 may be configured to communicate bi-directionally, via the antennas 235, with the display 130 over white space spectrum. Although antenna(s) 205, 235 are depicted separately, there may be common antenna(s). Also, while the mobile device 105 and display 130 are depicted as separate devices, they may in other examples be a single integrated device.

The memory 225 may include random access memory (RAM) and read-only memory (ROM). The memory 225 may store computer-readable, computer-executable software code 230 containing instructions that are configured to, when executed, cause a processor (e.g., a processor in the WWAN sub-module 215, white space sub-module 225, multimedia content module 115, or communication management subsystem 220) to perform various functions described herein (e.g., multimedia control, retrieval, and transmission, call processing, database management, message routing, etc.). Alternatively, the software 220 may not be directly executable by the processor but be configured to cause the computer, e.g., when compiled and executed, to perform functions described herein.

The WWAN sub-module 215, white space sub-module 225, multimedia content module 115, and communication management subsystem 220 may be implemented with an intelligent hardware device, e.g., a central processing unit (CPU) such as those made by Intel® Corporation or AMD®, a microcontroller, an application specific integrated circuit (ASIC), etc. Each transceiver module 210, 230 may include a modem configured to modulate the packets and provide the modulated packets to the respective antennas 205, 235 for transmission, and to demodulate packets received from respective antennas 205, 235.

As noted above, the mobile device 105 may transmit multimedia content control information via WWAN spectrum to the WWAN transceiver module 210 via antenna(s) 205. The WWAN sub-module 215 may manage aspects of power control, and registration of the mobile device in the femtocell 135-c.

The multimedia content module 115 may receive and process the multimedia content control information, and retrieve the multimedia content set forth in the received control information through the content source 120-b. The multimedia content module 115 may be connected with the content source 120-b via a wired or wireless connection.

The white space sub-module 225 may monitor spectrum, including the white space spectrum, allocated to broadcasting services nationally to detect signals from television stations and signals from auxiliary service stations (e.g., from wireless microphones). By identifying the unused frequencies, the white space sub-module 225 may thereby identify the white space spectrum. The WS transceiver module 230 may transmit the accessed multimedia content over white space spectrum to a display 130 via antenna(s) 235.

The femtocell 135-c may be in communication with other interfaces not explicitly shown in FIG. 2. For example, the femtocell 135-c may be in communication with a native cellular interface (e.g., a specialized transceiver utilizing cellular network communication techniques that may consume relatively large amounts of power in operation) for communicating with various appropriately configured devices through a native cellular wireless link (e.g., an “in band” communication link). Such a communication interface may operate according to various communication standards, including but not limited to wideband code division multiple access (W-CDMA), CDMA2000, global system for mobile telecommunication (GSM), worldwide interoperability for microwave access (WiMax), and wireless LAN (WLAN). Also or alternatively, the femtocell 135-c may be in communication with one or more backend network interfaces (e.g., a backhaul interface providing communication via the Internet, a packet switched network, a switched network, a radio network, a control network, a wired link, and/or the like) for communicating with various devices or other networks.

The terms “high power” and “low power” as used herein are relative terms and do not imply a particular level of power consumption. Accordingly, some devices may simply consume less power than native cellular interface (e.g., for communications with the macrocell) for a given time of operation. In some implementations, OOB interfaces may also provide relatively lower bandwidth communications, relatively shorter range communication, and/or consume relatively lower power in comparison to the macro communications interfaces. There is no limitation that the OOB devices and interfaces be low power, short range, and/or low bandwidth.

Various communications functions (e.g., including those of the femtocell 135-c) may be managed using the communications management subsystem 220. For example, the communications management subsystem 220 may at least partially handle communications with the macrocell (e.g., WWAN), one or more OOB networks (e.g., piconets, OOB radios, other femto-proxies, OOB beacons, etc.), one or more other femtocells, other mobile devices 105, etc. The communications management subsystem 220 may be a component of the femtocell 135-c in communication with some or all of the other components via a bus. Various other architectures are possible other than those illustrated by FIG. 2. The components need not be collocated, integrated into a single device, configured to share components, etc.

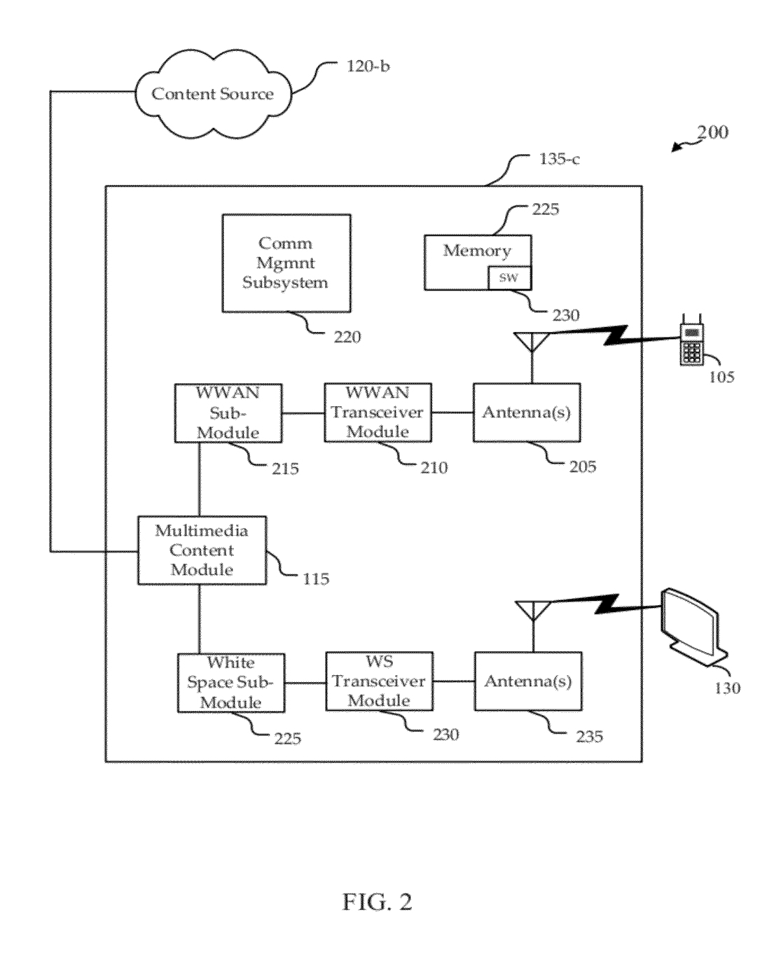

Referring next to FIG. 3, a block diagram illustrates an example of certain components of a processor module 300. The processor module 300 may be used in femtocell 135 of FIG. 1A, 1B, 1C, or 2. The processor module 300 includes WWAN module 110-a, multimedia content module 115-a, and white space module 125-b, and the functions may be similar to those described for the WWAN module 110, multimedia content module 115, and white space module 125 of FIG. 1A, 1B, or 1C.

The WWAN module 110-a is configured to receive a WWAN communication from a mobile device (e.g., mobile device 105). The WWAN module 110-a may determine how to handle the communication, including affecting operation of the femtocell. A mobile device may transmit multimedia content control information via wireless wide area network (WWAN) spectrum to the WWAN module 110-a. The multimedia content module 115-a may retrieve the multimedia content identifiable through the received control information. The white space module 125-b may wirelessly transmit the multimedia content over white space spectrum to a video display.

The components of the processor module 300 of FIG. 3 may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each module may include memory, or accessed memory may be elsewhere on (e.g., memory 215 of FIG. 2) on or off the processor module 300.

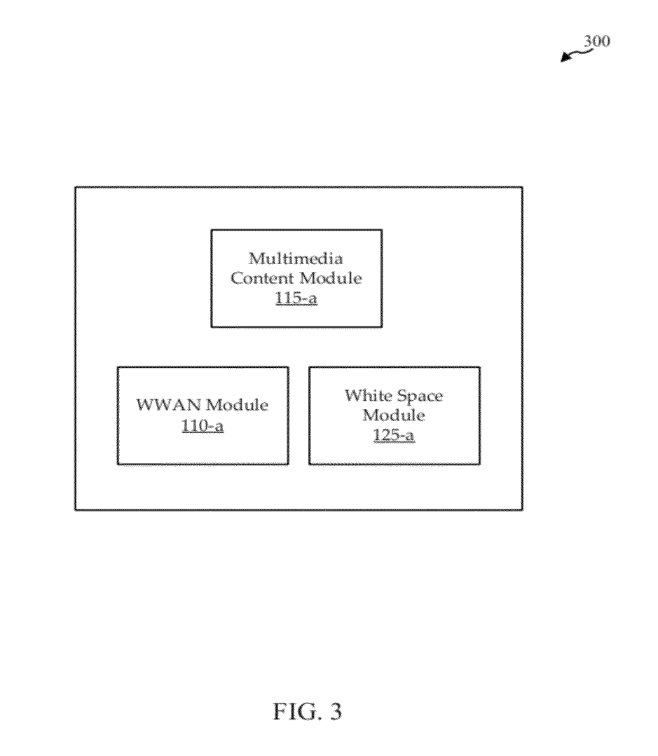

As described above, femtocell systems may be configured to communicate with client devices, such as mobile device 105 of FIG. 1A, 1B, 1C, or 2. FIG. 4 s a block diagram 400 of a mobile device 105-b for use with the femtocells described with reference to FIG. 1A, 1B, 1C, or 2, or in a femtocell implementing processor module 300 of FIG. 3. The mobile device 105-b may have any number of different configurations, such as personal computers (e.g., laptop computers, netbook computers, tablet computers, etc.), cellular telephones, PDAs, digital video recorders (DVRs), internet appliances, gaming consoles, e-readers, etc. The mobile device 105-a may have a mobile configuration, having an internal power supply (not shown), such as a small battery, to facilitate mobile operation.

The mobile device 105-a includes antenna(s) 405, a transceiver module 410, memory 415, and a processor module 425, which each may be in communication, directly or indirectly, with each other (e.g., via one or more buses). The transceiver module 410 is configured to communicate bi-directionally, via the antennas 405 and/or one or more wired or wireless links, with one or more networks, as described above. For example, the transceiver module 410 is configured to communicate bi-directionally with a femtocell 135 of FIG. 1A, 1B, 1C, or 2 and, more specifically, with the WWAN module 110 of FIG. 1A, 1B, or 1C. A display module 445 may generate and display a user interface to allow a user of the mobile device 105-b to select and control delivery of multimedia content.

In some examples, the mobile device 105-b is a dual-mode device, as the transceiver may also communicate bi-directionally with a white space module 125 of FIG. 1A, 1B, or 1C. The transceiver may thus be configured to receive signals over white space spectrum (and may, more specifically, be configured to receive signals over FLO spectrum). The display module 445 may receive, process, and display the multimedia content received over the white space spectrum.

In other examples, the transceiver module 410 may be configured to further communicate over other OOB links, alternatively or in addition to the interfaces described above. The transceiver module 410 may include a modem configured to modulate the packets and provide the modulated packets to the antennas 405 for transmission, and to demodulate packets received from the antennas 405. While the mobile device 105-b may include a single antenna, the mobile device 105-b will typically include multiple antennas 405 for multiple links.

The memory 415 may include random access memory (RAM) and read-only memory (ROM). The memory 415 may store computer-readable, computer-executable software code 420 containing instructions that are configured to, when executed, cause the processor module 425 to perform various functions described herein (e.g., call processing, database management, message routing, etc.). Alternatively, the software 420 may not be directly executable by the processor module 425 but be configured to cause the computer, e.g., when compiled and executed, to perform functions described herein.

The processor module 425 may include an intelligent hardware device, e.g., a central processing unit (CPU) such as those made by Intel® Corporation or AMD®, a microcontroller, an application specific integrated circuit (ASIC), etc. The processor module 425 may include a speech encoder (not shown) configured to receive audio via a microphone, convert the audio into packets (e.g., 30 ms in length) representative of the received audio, provide the audio packets to the transceiver module 410, and provide indications of whether a user is speaking. Alternatively, an encoder may only provide packets to the transceiver module 410, with the provision or withholding/suppression of the packet itself providing the indication of whether a user is speaking.

According to the architecture of FIG. 4, the mobile device 105-b further includes a communications management subsystem 440. The communications management subsystem 440 may manage communications with a macrocell network (e.g., a WWAN), one or more OOB networks, one or more femtocells, etc. For example, the communications management subsystem 440 may be a component of the mobile device 105-b in communication with some or all of the other components of the mobile device 105-b via a bus. Alternatively, functionality of the communications management subsystem 440 may be implemented as a component of the transceiver module 410, as a computer program product, and/or as one or more controller elements of the processor module 425.

Furthermore, the mobile device 105-b may also include OOB interfaces implemented as part of the transceiver module 410 and/or the communications management subsystem 440 (e.g., a transceiver that may consume relatively low amounts of power in operation and/or may cause less interference than in the in-band spectrum) for communicating with other appropriately configured devices through a wireless link.

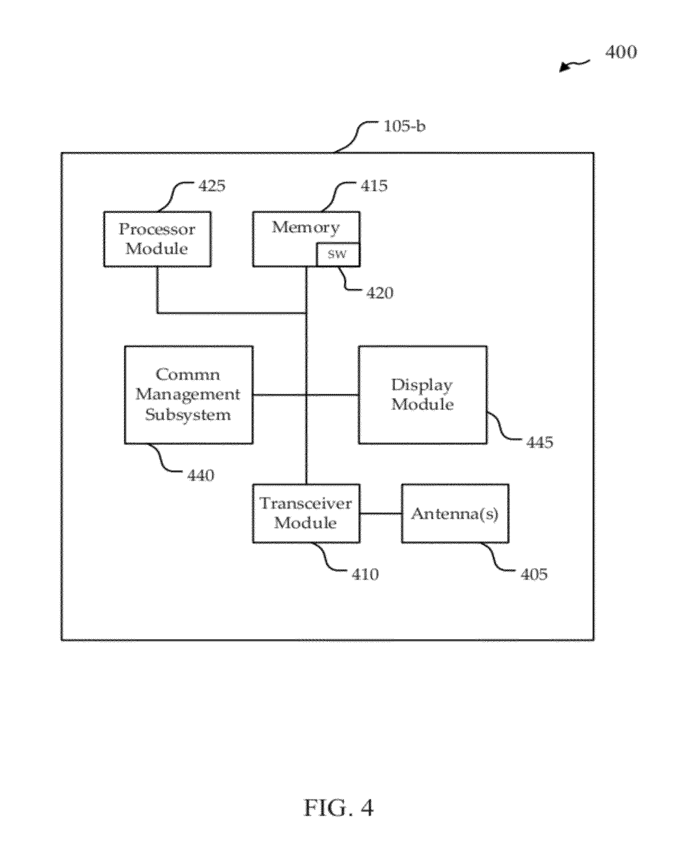

FIG. 5 is a flowchart of a method 500 for multimedia content delivery in a femtocell according to various embodiments of the invention. The method 500 may be performed, for example, in whole or in part, by the femtocell 135 of FIG. 1A, 1B, 1C, or 2, or the processor module 300 of FIG. 3.

At block 505, multimedia content control information is received via wireless wide area network (WWAN) spectrum from a mobile device. At block 510, multimedia content is transmitted over white space spectrum to a video display in response to the received multimedia content control information.

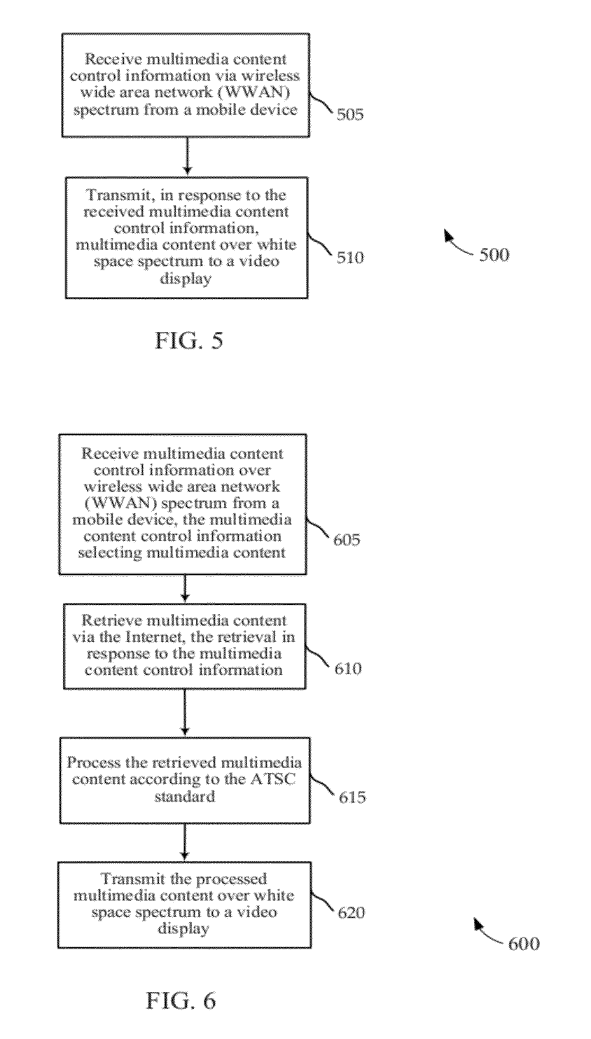

FIG. 6 is a flowchart of a method for the retrieval and delivery of multimedia content delivery at a femtocell according to various embodiments of the invention. The method 600 may be an example of the method 500 described with reference to FIG. 5. The method 600 may be performed, for example, in whole or in part, by the femtocell 135 of FIG. 1A, 1B, 1C, or 2, or the processor module 300 of FIG. 3.

At block 605, multimedia content control information is received over wireless wide area network (WWAN) spectrum from a mobile device, the multimedia content control information selecting multimedia content to be displayed. At block 610, the multimedia content is retrieved via the Internet, the retrieval in response to the multimedia content control information. At block 615, the retrieved multimedia content is processed according to the Advanced Television Systems Committee (ATSC) standards. At block 620, the processed multimedia content is transmitted over white space spectrum to a video display.

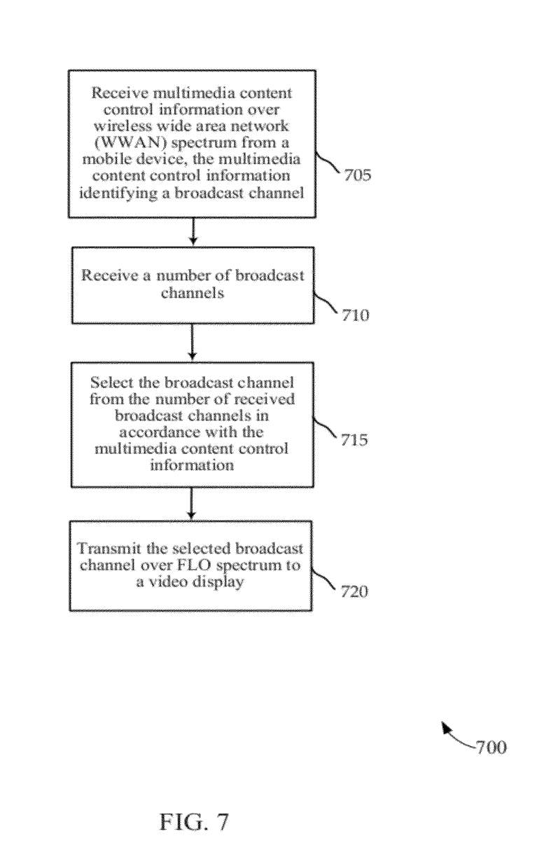

FIG. 7 is a flowchart of a method for multimedia content delivery at a femtocell using FLO spectrum according to various embodiments of the invention. The method 700 may be an example of the method 500 or 600 described with reference to FIG. 5 or 6. The method 700 may be performed, for example, in whole or in part, by the femtocell 135 of FIG. 1A, 1B, 1C, or 2, or the processor module 300 of FIG. 3.

At block 705, multimedia content control information is received over wireless wide area network (WWAN) spectrum from a mobile device, the multimedia content control information identifying a broadcast channel. At block 710, a number of broadcast channels are received. At block 715, the identified broadcast channel is selected from the number of received broadcast channels in accordance with the multimedia content control information. At block 720, the selected broadcast channel is transmitted over FLO spectrum to a video display.

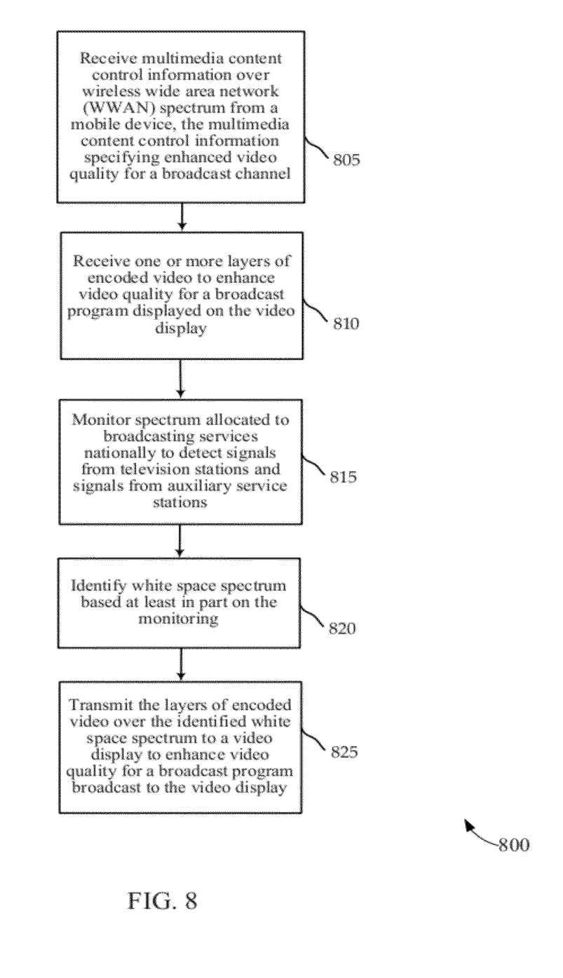

FIG. 8 is a flowchart of a method 800 of monitoring white space spectrum and transmitting layers of encoded video data over a femtocell according to various embodiments of the invention. The method 800 may be an example of a method 500, 600, or 700 described with reference to FIG. 5, 6, or 7. The method 800 may be performed, for example, in whole or in part, by the femtocell 135 of FIG. 1A, 1B, 1C, or 2, or the processor module 300 of FIG. 3.

At block 805, multimedia content control information is received over wireless wide area network (WWAN) spectrum from a mobile device, the multimedia content control information specifying enhanced video quality for a broadcast channel. At block 810, one or more layers of encoded video are received, the layers formatted to enhance video quality for a broadcast program displayed on a video display. At block 815, spectrum allocated to broadcasting services nationally is monitored, the monitoring performed to detect signals from television stations and signals from auxiliary service stations. At block 820, white space spectrum is identified based at least in part on the monitoring. At block 825, the layers of encoded video are transmitted over the identified white space spectrum to a video display to enhance video quality for a broadcast program broadcast to the video display.

### Considerations Regarding the Description

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can be read-only memory (ROM), random access memory (RAM), magnetic RAM, core memory, optical storage mediums or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A system of multimedia content delivery, the system comprising:
a mobile device, in communication with a femtocell via wireless wide area network (WWAN) spectrum, and configured to transmit multimedia content control information to the femtocell over the WWAN spectrum; and
the femtocell configured to:
receive the multimedia content control information over the WWAN spectrum; and
transmit, responsive to the multimedia content control information, multimedia content over white space spectrum to a video display.

2. The system of claim 1, wherein the femtocell is further configured to:
retrieve the multimedia content via a wired connection to the Internet, the retrieval responsive to the multimedia content control information.

3. The system of claim 2, further comprising:
a home computing device, in communication with the femtocell and distinct from a mobile device, wherein the femtocell is further configured to retrieve the multimedia content from the Internet via the home computing device.

4. The system of claim 1, wherein the femtocell is further configured to:
receive a plurality of broadcast signals; and
identify a selected one of the broadcast signals comprising the multimedia content for transmission, the identification according to the multimedia content control information.

5. The system of claim 1, wherein the mobile device is further configured to:
generate and display a user interface to allow a user of the mobile device to select the multimedia content.

6. The system of claim 1, wherein the white space spectrum comprises spectrum allocated to broadcasting services nationally, wherein the white space spectrum is unallocated locally.

7. The system of claim 5, wherein the femtocell is further configured to:
monitor spectrum, including the white space spectrum, allocated to broadcasting services nationally to detect signals from television stations and signals from auxiliary service stations; and
identify the white space spectrum based at least in part on the monitoring.

8. The system of claim 1, wherein the multimedia content comprises one or more layers of encoded video to enhance video quality for a broadcast program displayed on the video display.

9. The system of claim 1, wherein the white space spectrum comprises spectrum allocated for use with a Forward Link Only air interface specification.

10. A method of multimedia content delivery, the method comprising:
receiving multimedia content control information via wireless wide area network (WWAN) spectrum from a mobile device; and
transmitting, responsive to the received multimedia content control information, multimedia content over white space spectrum to a video display.

11. The method of claim 10, further comprising:
retrieving the multimedia content via the Internet, the retrieval responsive to the multimedia content control information.

12. The method of claim 10, further comprising:
receiving a plurality of broadcast signals; and
identifying, according to the multimedia content control information, a selected one of the broadcast signals comprising the multimedia content.

13. The method of claim 10, wherein white space spectrum comprises spectrum allocated to broadcasting services nationally, wherein the white space spectrum is unallocated locally.

14. The method of claim 10, further comprising:
monitoring spectrum allocated to broadcasting services nationally including the white space spectrum to detect signals from television stations and signals from auxiliary service stations; and
identifying the white space spectrum based at least in part on the monitoring.

15. The method of claim 10, wherein the multimedia content comprises one or more layers of encoded video to enhance video quality for a broadcast program on the video display received via a wired connection.

16. The method of claim 10, wherein the white space spectrum comprises spectrum allocated to a Forward Link Only air interface specification.

17. A femtocell for multimedia content delivery, the femtocell comprising:
a wireless wide area network (WWAN) spectrum receiver, configured to receive multimedia content control information via WWAN spectrum from a mobile device; and
a white space spectrum transmitter, communicatively coupled with the WWAN spectrum receiver, and configured to transmit multimedia content over the white spaces spectrum directed to a video display.

18. The femtocell of claim 17, further comprising:
a multimedia content module, communicatively coupled with the WWAN spectrum receiver and the white space spectrum transmitter, and configured to:
process the multimedia content control information to identify the multimedia content for transmission; and
retrieve the multimedia content via the Internet.

19. The femtocell of claim 17, further comprising:
a multimedia content module, communicatively coupled with the WWAN spectrum receiver and the white space spectrum transmitter, and configured to:
receive a plurality of broadcast signals; and
process the multimedia content control information to identify the multimedia content for transmission from the plurality of broadcast signals.

20. The femtocell of claim 17, wherein the white space spectrum comprises spectrum allocated to broadcasting services nationally, wherein the white space spectrum is unallocated locally.

21. The femtocell of claim 17, further comprising:
a white space detection module, communicatively coupled with the white space spectrum transmitter, and configured to:
monitor spectrum allocated to broadcasting services nationally including the white space spectrum to detect signals from television stations and signals from auxiliary service stations; and
identify the white space spectrum based at least in part on the monitoring.

22. The femtocell of claim 17, wherein the multimedia content comprises one or more layers of encoded video useable to integrate with a broadcast program on the video display to enhance video quality.

23. The femtocell of claim 17, wherein white space spectrum comprises spectrum allocated to a Forward Link Only air interface specification.

24. A device for multimedia content delivery, the device comprising:
means for receiving multimedia content control information via wireless wide area network (WWAN) spectrum from a mobile device; and
means for transmitting, responsive to the received multimedia content control information, multimedia content over white space spectrum directed to a video display.

25. The device of claim 24, further comprising:
means for retrieving the multimedia content via the Internet, the retrieval responsive to the multimedia content control information.

26. The device of claim 24, further comprising:
means for receiving a plurality of broadcast signals; and
means for identifying, according to the multimedia content control information, a selected one of the broadcast signals comprising the multimedia content.

27. The device of claim 24, further comprising:
means for monitoring spectrum allocated to broadcasting services nationally including the white space spectrum to detect signals from television stations and signals from auxiliary service stations; and
means for identifying the white space spectrum based at least in part on the monitoring.

28. The device of claim 24, wherein the white space spectrum comprises spectrum allocated to broadcasting services nationally, wherein the white space spectrum is unallocated locally.

29. The device of claim 24, further comprising:
means for retrieving one or more layers of encoded video formatted to enhance video quality for a broadcast program on the video display.

30. The device of claim 24, wherein the white space spectrum comprises spectrum allocated to a Forward Link Only air interface specification.

31. A computer program product, comprising:
a computer-readable medium comprising:
code for receiving multimedia content control information via wireless wide area network (WWAN) spectrum from a mobile device; and
code for transmitting, responsive to the received multimedia content control information, multimedia content over white space spectrum directed to a video display.

32. The computer program product of claim 31, wherein the computer-readable medium further comprises:
code for retrieving the multimedia content responsive to the multimedia content control information.

33. The computer program product of claim 31, wherein the computer-readable medium further comprises:
code for receiving a plurality of broadcast signals; and
code for identifying, according to the multimedia content control information, a selected one of the broadcast signals comprising the multimedia content.

34. The computer program product of claim 31, wherein the computer-readable medium further comprises:
code for monitoring spectrum allocated to broadcasting services nationally including the white space spectrum to detect signals from television stations and signals from auxiliary service stations; and
code for identifying the white space spectrum based at least in part on the monitoring.
